(19) United States
(12) Patent Application Publication
(10) Pub. No.: US 2010/0126349 A1
(43) Pub. Date: May 27, 2010

(54) REDUCED TEMPERATURE SCRUBBING OF EFFLUENT GAS

(75) Inventor: Robbert M. Vermeulen, Pleasant Hill, CA (US)

Correspondence Address: DUGAN & DUGAN, PC, 245 Saw Mill River Road, Suite 309, Hawthorne, NY, 10532, US

(73) Assignee: Applied Materials, Inc., Santa Clara, CA (US)

(21) Appl. No.: 12/324,695

(22) Filed: Nov. 26, 2008

(51) Int. Cl. B01D 47/00; H01S 4/00

(52) U.S. Cl. 95/229; 96/243; 29/592.1

(57) ABSTRACT

Systems, apparatus and methods are provided involving a reduced-temperature wet scrubbing system adapted to scrub effluent gases within an abatement system. The reduced-temperature wet scrubbing system may include a wet scrubber adapted to be operated within a range of reduced temperatures and a cooling system adapted to maintain the wet scrubber within the range of reduced temperatures, which is below 23° C. The cooling system may include a coolant, preferably chilled water, adapted to cool the wet scrubber. The wet scrubbing system further may include an indication device, such as a temperature sensor, to indicate whether the wet scrubber is within the temperatures range. A controller in communication with the indication device may be provided to control the cooling system. In addition, the wet scrubbing system may include baffles and nozzles spraying chilled mist along a path of the effluent gas between an abatement tool and the wet scrubber.

### CROSS REFERENCE TO RELATED APPLICATIONS

Co-assigned U.S. patent application Ser. No. 12/202,219, filed Aug. 29, 2008 and entitled “METHODS AND APPARATUS FOR ABATING ELECTRONIC DEVICE MANUFACTURING TOOL EFFLUENT,” (Attorney Docket No. 12701) is hereby incorporated herein by reference in its entirety for all purposes.

Co-assigned U.S. Patent Application No. 61/080,131, filed Jul. 11, 2008 and entitled “METHODS AND APPARATUS FOR MONITORING WASTE CONCENTRATION IN A SCRUBBER FLUID OF AN ABATEMENT SYSTEM,” (Attorney Docket No. 11628/L) is hereby incorporated herein by reference in its entirety for all purposes.

### FIELD OF THE INVENTION

Aspects of the present invention relate to abatement systems in microelectronic structure and/or electronic device processing systems. In particular, embodiments of the present invention relate to improved scrubbing of effluent gases, such as of an abatement system.

### BACKGROUND OF THE INVENTION

Many electronic device manufacturing processes are conducted in systems that include process chambers. Process chambers typically may be operated at reduced pressure, also referred to as partial vacuum or vacuum conditions. Such processes include chemical vapor deposition, and physical vapor deposition, etc. For instance, thin-film solar cell manufacturing technology typically involves the deposition of thin films of amorphous and/or microcrystalline silicon from silane and other silicon-bearing compounds.

Deposition conventionally occurs in a manufacturing system including a process chamber in fluid communication with other systems and apparatus, such as process gas supplies and abatement tools. Large quantities of gas may enter and exit the chamber during the deposition process because the utilization rate of these gases in the chamber often is very low. Silane and silicon-bearing gases exiting the chamber typically are abated in specialized abatement systems that use combustion and generate large quantities of silica powder, among other substances.

Some of the silica powder generated in the abatement system generally is flushed out of an abatement tool using water, and the water transports the silica powder away from the tool. Gases also may exit the tool, and these gases may include particulates as well. These gases may be transported to, and scrubbed by, point of use wet scrubbers as well as house exhaust systems. The scrubbers may remove particulates from the gases using water sprays and packed filter beds. The gases and the packed beds may be sprayed with water to remove the particulates from the gases and from the scrubber. However, some gases, moisture, and particulates conventionally get past the scrubber and end up in ductwork beyond the scrubber, and possibly may clog and/or corrode the ductwork.

Insofar as the accumulation of solids and condensation of gases in the ductwork is a foreseeable event, operators frequently may need to perform preventive maintenance (PM) to keep the ductwork clean, and occasionally replace portions of the equipment. Such PM may be quite extensive and frequent. That is to say, the processing system may need to be paused at regular intervals, sometimes as frequently as once or twice a week, to empty the ductwork of particulates, clean the ductwork of corrosive substances, and/or replace ductwork components. Such frequent preventive maintenance may introduce undesired delays in the manufacturing system, possibly increasing processing times, decreasing throughput, and/or increasing per-unit costs.

As such, a technology would be desirable that would reduce processing times, increase throughput, and/or decrease per-unit costs by reducing the frequency of preventive maintenance that requires a stoppage or delay of the processing system. Likewise, a technology would be desirable that may reduce the frequency of PM by reducing the frequency with which a ductwork, a wet scrubber, or a component thereof, needs to be cleaned, emptied or replaced. Accordingly, embodiments of the present invention may improve upon the prior art by providing a means by which a wet scrubber of an abatement system may remove moisture and particulates from effluent gases more effectively, to reduce corrosion, condensation, particulate accumulation, and/or gas flow impedance in the exhaust system without introducing a pause, stoppage or delay in the processing system.

### SUMMARY OF THE INVENTION

Aspects of the present invention involve a reduced temperature wet scrubbing system. Other aspects involve incorporation of a reduced temperature wet scrubbing system in, for instance, an exhaust transport system of an abatement system of a manufacturing system of microelectronic structures and/or electronic devices.

Some embodiments of the invention may involve a reduced temperature wet scrubbing system including a wet scrubber and a cooling system. The wet scrubber may be adapted to be operated at an operating temperature within a range of reduced temperatures, and the cooling system may be adapted to maintain the wet scrubber within that range, which may be below twenty-three degrees Celsius (23° C.).

In various embodiments of the present invention, the cooling system may have, create or connect to, a cooled liquid source, such as a liquid refrigeration device, from which coolant may flow to cool the wet scrubber, such as by supplying the wet scrubber with cooled liquid, e.g., chilled water, for use in spraying the effluent gases and packed beds and/or baffles. For instance, the chilled water may have a coolant temperature within a coolant temperature range from zero degrees Celsius (0° C.) to fifteen degrees Celsius (15° C.).

Other embodiments of the present invention may involve a method of scrubbing effluent gas. The method may include providing a reduced-temperature wet scrubbing system; and operating the reduced-temperature wet scrubbing system at an operating temperature within a range of reduced temperatures, which is below twenty-three degrees Celsius (23° C.). In this method, the reduced-temperature wet scrubbing system includes a wet scrubber adapted to be operated at the operating temperature within the range of reduced temperatures, and a cooling system adapted to maintain the wet scrubber within the range of reduced temperatures.

Further embodiments of the present invention may involve a method of making a reduced-temperature wet scrubbing system. The method may include providing a wet scrubber adapted to be operated at an operating temperature within a range of reduced temperatures; and providing a cooling system adapted to maintain the wet scrubber within the range of reduced temperatures, which is below twenty-three degrees Celsius (23° C.)

Additional embodiments of the present invention may involve a method of making a microelectronic structure processing system. The method may include providing a reduced-temperature wet scrubbing system, wherein the reduced-temperature wet scrubbing system includes a wet scrubber adapted to be operated at an operating temperature within a range of reduced temperatures; and a cooling system adapted to maintain the wet scrubber within the range of reduced temperatures, which is below twenty-three degrees Celsius (23° C.).

Still further embodiments of the present invention may a microelectronic structure processing system that includes a reduced-temperature wet scrubbing system. The reduced-temperature wet scrubbing system includes a wet scrubber adapted to be operated at an operating temperature within a range of reduced temperatures; and a cooling system adapted to maintain the wet scrubber within the range of reduced temperatures; an abatement tool connected to the reduced-temperature wet scrubbing system; and a water circulation system connected to the abatement tool and the reduced-temperature wet scrubbing system. The range of reduced temperatures is below 23° C.

### BRIEF DESCRIPTION OF THE DRAWINGS

To facilitate explanation of various features, aspects, embodiments, and advantages of the present invention, a detailed description of the invention refers to embodiments of the invention illustrated in the appended drawings.

The appended drawings illustrate only typical embodiments of the present invention, which are not necessarily to scale, and are therefore not to be considered limiting of its scope, for the invention may admit to other equally effective embodiments and equivalents thereof.

FIG. 1 depicts a schematic of an exemplary processing system having an abatement system with a reduced-temperature wet scrubbing system in accordance with an aspect of the present invention.

FIG. 2 depicts a schematic of an exemplary reduced-temperature wet scrubbing system having a wet scrubber and liquid refrigeration device in accordance with an embodiment of the present invention.

FIGS. 3A-3C depict schematics of a front view, a cross-sectional perspective view, and a top sectional plan view of components of an exemplary processing system in accordance with a further embodiment of the present invention.

FIGS. 4A-4B depict schematics of a cross-sectional front view and a perspective view of additional components of another exemplary processing system in accordance with another embodiment of the present invention.

### DETAILED DESCRIPTION OF THE INVENTION

The following detailed examples depict one or more exemplary embodiments of the present invention. Although in some cases the document may imply that the invention may only be practiced in one way, it should be understood that many alternative embodiments are possible and that the specific details disclosed herein are merely provided as examples.

As introduced above, effluent gas abatement results in several waste by-products. For instance, water and particulates from an abatement tool and a scrubber may collect in a sump. The particulate-containing water in the sump may be strained while being transported to and filtered by a filter, which is used to remove much of the silica powder and other particulates present in the sump water. A pump may be used to transport the strained but unfiltered water from the sump to the filter. The pump also may transport the filtered water from the filter to a heat exchanger, where the filtered water may be cooled and recycled for use in the scrubber or the abatement tool. The sump, filter, pump, and heat exchanger may comprise a water circulation system. Likewise, the water circulation system and the abatement tool may comprise the abatement system. Similarly, the abatement system and a deposition system, including the process chamber, for instance, may comprise the electronic device manufacturing system at large.

When a conventional wet scrubber is used to abate an effluent gas stream that contains particulates, the efficiency for particulate capture may typically be low for submicron particulates. A wet scrubber often may saturate the effluent gas stream to 100% relative humidity at the effluent gas discharge temperature. High relative humidity exists when the temperature of a gas is not much above the dew point. At a specific pressure and absolute water vapor content, water vapor may begin to condense from a gas when the temperature of the gas drops to a temperature corresponding to the “dew point” or “dewpoint.” When the relative humidity of a gas reaches 100%, the temperature of the gas is equal to the dew point.

Given a constant dew point, an increase in temperature of the gas will lead to a decrease in the relative humidity of the gas. Conversely, a sufficient decrease in temperature of the gas may result in the gas becoming saturated with water vapor, crossing the dew point curve, and having water condense out of the gas. A gas is considered saturated when it attains a high relative humidity approaching 100% relative humidity.

Typical effluent gases may be super saturated. If after the scrubber a gas stream encounters a surface having a temperature that is colder than the gas itself, or if the temperature of the gas stream drops sufficiently for the relative humidity of the gas to reach or exceed 100%, condensation will occur. Thus, condensation may occur in the house ductwork as effluent gases exit the wet scrubber. As effluent gases cool, the dew point may be crossed, or the effluent gas otherwise may be carrying more water vapor than can be held in the gas phase. When the effluent gas contains hydrofluoric acid, HF, for example, the water that condenses may be acidic.

Condensation occurring in the house ductwork may result in ductwork corrosion. Ductwork corrosion may occur, for example, when HF-vapor and water vapor condense, in which case aqueous HF will form, and the acid will drip from and corrode the ductwork. For instance, if there is liquid in duct, that water can absorb HF vapor. The HF-vapor may combine with water vapor as it condenses when the dew point is crossed in a house exhaust system where free F₂ or HF is present in ductwork (from the NF₃ cleans). Although water vapor and F₂ gas react slowly, they react more quickly in the presence of a surface.

Moreover, crossing the dew point will cause the water vapor to condense, and condensed water and F₂ react more quickly than the two gases without a surface. The F₂ may react with the water to form HF. Ductwork corrosion also may be caused when free F₂ and HF dissolve into condensate water puddles in the duct work. Likewise, ductwork corrosion may arise when F₂ emissions at the point of use (POU) effectively bypass the house scrubber because F₂ is scrubbed much more slowly than HF in a house water scrubber. The reaction rate for conversion to HF is lower. Although F₂ does react with the water, and some may come back out of the solution.

As such, problems may arise as the effluent gases exit the wet scrubber, inasmuch as the effluent gases may contain moisture and particulates that may condense and/or accumulate in the ductwork of the house exhaust system. Insofar as effluent gases may be hotter than ambient air upon exiting the wet scrubber, the effluent gases may cool as they travel through the ductwork. As the effluent gases cool, moisture therein may condense and collect in the ductwork. As gas impacts moist surfaces of the ductwork, some particulates may stick to the moist surface and accumulate into larger pieces of solid material that may coat portions of the ductwork interior.

Similarly, some of the remaining particulates may fall out of suspension in the effluent gases with condensation of the moisture. In addition, particulates suspended in effluent gas may nucleate the condensation. Other physical, chemical or electromagnetic forces also may be at work to knock particulates and/or moisture out of the effluent gases, such as bends in the ductwork or an electrostatic charge differential between the particulates and walls of the ductwork. As described above, these deposited particulates and condensation possibly may corrode the ductwork, reduce gas throughput, and/or slow the entire electronic device manufacturing system.

In one aspect of the present invention, an abatement system manages the total water and particulate content in effluent gases, so that the effluent gas is not, and does not become, saturated after exiting a wet scrubber. Consequently, the effluent gas does not condense water vapor when the effluent gas cools in the house system. In an electronic device manufacturing system, sources of water vapor may include, for example, combustion by-product water, humidity in 50% RH dilution fab air; and cooling injection of ambient water. In conventional systems, as gases pass through a scrubber, they equalize with the water that moves down through the scrubber, forming a 100% relative humidity gas coming out of the scrubber.

Embodiments of the present invention may manage the total water and particulate content in effluent gases by application of reduced temperatures. While not wishing to be bound to any particular theory, the application of reduced temperature may result in thermophoresis. Thermophoresis is a process by which particulates may be drawn to a surface that is colder than the temperature of the particulates and/or the gas in which the particulates are entrained. Thermophoresis may occur when the surface is that of a solid or of a liquid. For instance, cold liquid droplets may be capable of capturing particulates. Aspects of the present invention use interaction between effluent gas and a cold surface in a wet scrubber to improve scrubbing efficiency and effectiveness. A wet scrubber of higher efficiency and effectiveness may extend the PM interval time during which a wet scrubber and gas transport ductwork can remain in service without pausing the electronic device manufacturing system for maintenance.

By using a liquid stream in the wet scrubber that is substantially cooler than the gas stream containing particulates, the fine particulates may be drawn to the liquid and into the water droplets by thermophoresis, thus improving the particulate capture efficiency. The gas stream may also be cooled by the liquid, and if the liquid is cool enough, the exiting gas stream may be below ambient temperature (e.g., temperatures within the house ductwork) and less prone to condensation. Insofar as ambient temperatures in ductwork distal from the combustion may be above 23° C., the range of reduced temperatures may be below 23° C. In addition, the solubility of a gas is normally higher in cold liquids, and thus the wet scrubber may also be more efficient. Embodiments of the present invention also may be used in conjunction with embodiments of a related invention claimed in a commonly-owned patent application directed to a reagent injection that converts F₂ to HF, which is more easily scrubbed in the house system.

Moreover, particulate collection efficiencies of water droplets have been calculated by considering thermophoresis, diffusiophoresis, inertial impaction, wake capture, and effects of drop deformation. In particular, experiments have been conducted that are unrelated to the use of thermophoresis in wet scrubbers, in which experimental computations were carried out for a droplet temperature of 10° C. with saturated gas temperatures of 20°, 35°, 65°, and 95° C. The temperature, water vapor, and velocity distributions around a collector were determined by direct numerical integration of the appropriate governing partial differential equations using a convenient orthogonal grid generation technique. The investigation showed that deposition of fine particulates can be significantly enhanced by phoretic forces and that flux deposition of fine particulates can be related to Reynolds number through the proportionality, E_{flux} α Re^{-0.78}. The flux deposition of fine particulates on the rear of the collector was significant for low Reynolds numbers. Also observed were that wake capture may be relatively insignificant and that drop deformation can improve the collection of larger particulates by inertial impaction and of smaller particulates as a result of increased hydrodynamic effects on such particulates.

Exemplary Electronic Device Manufacturing System

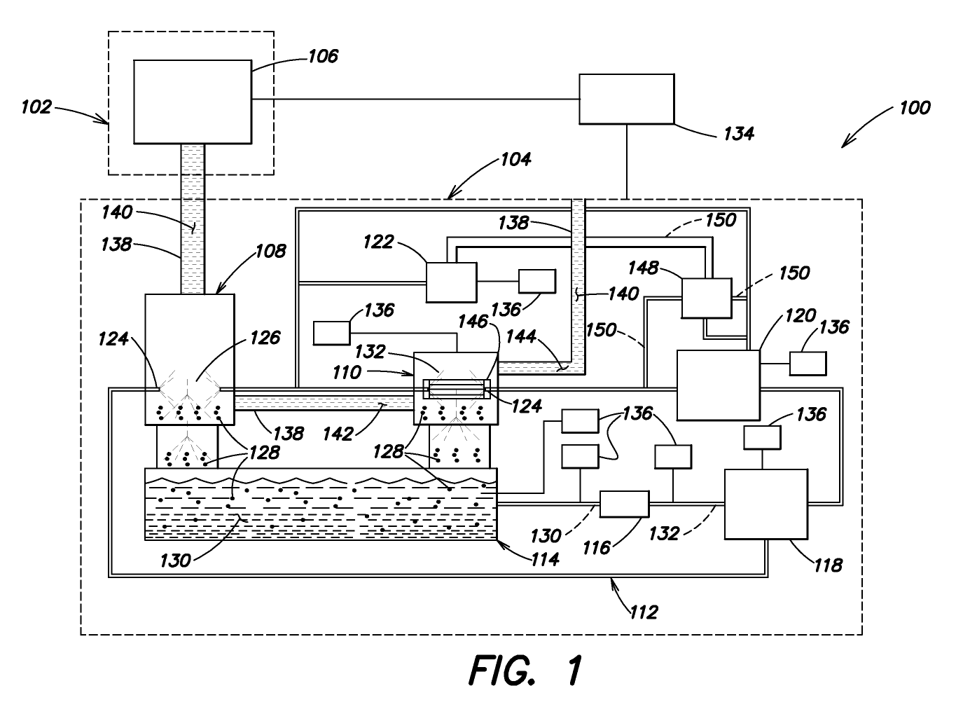

Referring to FIG. 1, a schematic of an exemplary electronic device manufacturing system 100 in accordance with an embodiment of the present invention is depicted. The electronic device manufacturing system 100 may include a deposition system 102 and an abatement system 104. The deposition system 102 may include a process chamber 106. The process chamber 106 may be connected to the abatement system 104. The abatement system 104 may comprise an abatement tool 108, a wet scrubber 110, and a water circulation system 112 connected to the abatement tool 108 and scrubber 110. The water circulation system 112 may comprise a sump 114, a filter site 116, a pump 118, and a heat exchanger 120. A fresh water supply 122 also may be connected to the abatement tool 108 and the scrubber 110.

Nozzles 124 may spray water 126 into the abatement tool 108 and the scrubber 110 to flush particulates 128 in the sump 114, where the water 126 and particulates 128 may collect, be removed, or get passed along for later removal. For instance, some particulates may not necessarily collect in the sump, but instead may be dispersed in the sump water before being pumped out to drain and replaced with fresh water. There may be both a suction strainer for removal of larger particulates, and a smaller mesh filter, possibly after the pump, to protect the heat exchanger and the spray jets. The mesh of a suction strainer may strain particulates larger than about 3/16 in diameter, and the holes in a small mesh filter may prevent particulates from reaching the spray nozzles and heat exchanger that are about 3/32 and smaller.

The pump 118 may transport the unfiltered, particulate-containing water 130 from the sump 114 to the filter site 116, where it is filtered. Alternatively, a suction strainer may pull the water from sump. The suction strainer may be in the sump water itself, and if the water is pulled into the suction strainer at a low enough velocity, the strained particulates will not be held against the strainer. Thus, they will not clog it, but instead may fall to the sump bottom and eventually have to be scooped out during PM. The pump 118 then may transport the filtered water 132 from the filter site 116 to the heat exchanger 120, where the filtered water 132 may be cooled and recycled for use in the scrubber 110 or the abatement tool 108.

The electronic device manufacturing system 100 also may include at least one controller 134 connected to one or more indication devices, such as sensors 136, from which the controller 134 may receive indication information about the operation of the system 100, such as the temperatures of water and/or components, the rates of flow of unfiltered water 130 and/or filtered water 132 to and/or from the filter site 116, etc. The indication information may indicate, for example, if the water needs to be cooled more, or if the filter site 116 is clogging or clogged with particulates 128.

The abatement system 104 includes an exhaust transport system 138, which may include various pipes, tubing, valves, etc., that regulate and facilitate the flow of effluent gases 140 from, for instance, the process chamber 106 to the abatement tool 108, then to the wet scrubber 110, and further to other processing or containment equipment. Effluent gas 142 leaving the abatement tool 108 preferably has fewer contaminants than effluent gas 140 entering the abatement tool 108. Combustion of effluent gas 140 combines with water 126 sprayed from nozzles 124 to remove a first portion of the contaminants, such as particulates 128. Likewise, effluent gas 144 leaving the wet scrubber 110 preferably has fewer contaminants than effluent gas 142 entering the wet scrubber 110. The wet scrubber 110 uses at least one packed bed 146 to extract contaminants, such as particulates 128, which may be rinsed into the sump 114 with water 132, for instance.

The wet scrubber 108 may be cooled by a refrigeration device 148 that may cause the wet scrubber 108 to operate at an operating temperature within a range of reduced temperatures. The refrigeration device 148 may include, for instance, a liquid refrigeration device for chilling water supplied to the wet scrubber 110, either from the heat exchanger 120, or from the fresh water supply 122, to create chilled water 150. The chilled water 150 preferably may have a chilled water temperature of, for example, between zero degrees Celsius (0° C.) and fifteen degrees Celsius (15° C.). While the coolant temperature preferably stays within a coolant temperature range from 0° C. to 15° C., the range of reduced temperatures may be offset from the coolant temperature range upwards by a few degrees to account for heat absorbed from the effluent gases. For example, the range of reduced temperatures may be from two degrees Celsius (2° C.) to twenty degrees Celsius (20° C.), depending on the relative temperatures and volume flow rates of the coolant and effluent gases.

As used herein, the term “effluent” refers to any gas or liquid traversing the manufacturing system and traveling away from the processing chamber 106. For instance, combustion exhaust from the abatement tool 108 would be an effluent in the system that may be scrubbed by the wet scrubber 110. Similarly, the term “particulate” refers to any non-gaseous substance occurring with or derived from the effluent gases. For example, combustion particles leaving the abatement tool 108 and precipitates forming in the wet scrubber 110 would be considered particulates. As used herein, particulates are not limited to substances suspended in gas.

Exemplary Reduced-Temperature Wet Scrubbing System

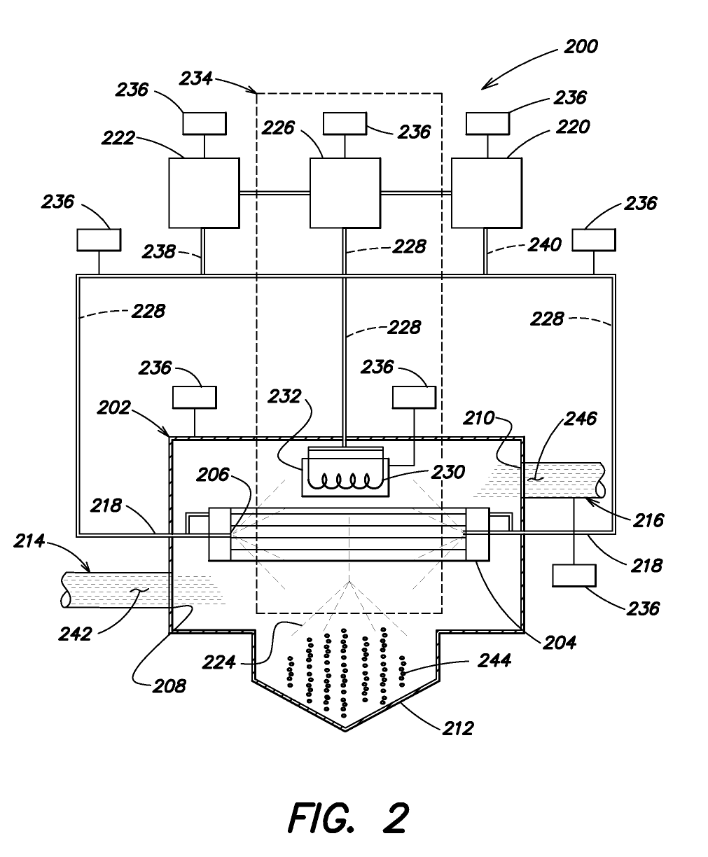

Referring to FIG. 2, a schematic of an exemplary reduced-temperature wet scrubbing system 200 according to an embodiment of the present invention is depicted. The reduced-temperature wet scrubbing system 200 may comprise a wet scrubber, as shown in FIG. 1. The wet scrubber may be adapted to be operated at an operating temperature within a range of reduced temperatures, and an associated cooling system may be adapted to maintain the wet scrubber within the range of reduced temperatures.

The wet scrubbing system 200 is depicted as including a scrubbing container 202, packed beds 204, nozzles 206, a gas entrance port 208, a gas exit port 210, and a drain 212. The scrubbing container 202 is in fluid communication via gas entrance port 208 and an exhaust input channel 214 with an abatement tool as shown in FIG. 1. Similarly, the scrubbing container 202 is in fluid communication via gas exit port 210 and an exhaust output channel 216 with further processing equipment as shown in FIG. 1.

In addition, the scrubbing container 202 is in fluid communication via nozzles 206 and water input channels 218 with a heat exchanger 220 and a fresh water supply 222. The heat exchanger 220 and fresh water supply 222 provide water 224 to the nozzles 206 via the water input channels 218. As shown in FIG. 2, a refrigeration device 226 is connected to the scrubbing container 202, the packed beds 204, and/or the water input channels 218 as a means of cooling the wet scrubbing system 200. The refrigeration device 226 preferably uses chilled water 228 as the coolant by which it cools the packed beds 204, thereby also cooling the scrubbing container 202, and ultimately the wet scrubbing system 200 as well.

Alternatively, other coolants and arrangements may be employed, such as in a self-contained loop of refrigerant 228 between a cooling coil 230 and the refrigeration device 226. Any refrigerant 228 suitable for the process environment may be selected. Such a cooling coil 230 may reside in a cooling plate 232 in the container 202, in the packed bed 204, or by itself in the container 202. The refrigeration device 226, coolant 228 (e.g., chilled water 228), cooling coil 230, cooling plate 232 collectively may be referred to, for example, as a cooling system 234.

The cooling system 234 also may include indication means, such as sensors 236, which may be used to monitor desired parameters, such as the temperatures of various components of the system 234, the water 224 and/or the coolant 228 flowing therein, or both. The sensors 236 also may be connected to a controller that monitors and regulates the electronic device manufacturing system at large, as shown in FIG. 1, and the cooling system 234, more specifically. The controller may be programmed to keep various locations within specified temperature ranges, for example, and maintenance of specific temperatures may be achieved, for instance, by adjusting the refrigerator device 226 up or down, or by adjusting a mixture of chilled water 228 and fresh water 238 and/or recirculated water 240.

An advantage of using water, and more specifically chilled water 228, however, is that the same chilled water 228 used to cool the system 200 also may be used to wash away the particulates and trapped gases that exit the container 202 through the drain 212, en route to be re-circulated in the water circulation system as depicted in FIG. 1. Insofar as conventional wet scrubbers already have nozzles 206 that spray water 224 to wash away particulates, conventional wet scrubbers could be modified post-manufacture, e.g., retrofitted, to include a cooling system 234 using chilled water 228 as the coolant 228 and spraying the chilled water 228 directly on the packed beds 204.

As discussed in FIG. 1, unscrubbed effluent gas 242 may enter the scrubbing container 202 from exhaust input channel 214 through the gas entrance port 208. The unscrubbed effluent gas 242 then is sprayed with water 224, e.g., chilled water 228, as it encounters the packed beds 204, which also preferably are sprayed with chilled water 228. The gas 242 is cooled as it mixes with the chilled water 228 and impacts the packed beds 204. Some gaseous by-products may condense out of the effluent gas 242 as the temperature of the effluent gas 242 drops, lowering the dew point of the effluent gas 242. In addition, particulates in the gas 242 may stick to, or be knocked out of gaseous suspension through contact with, falling water vapor, condensation, and/or the packed beds 204.

As a result, the unscrubbed effluent gas 242 is scrubbed of water-soluble gases, particulates, and such contaminant by-products 244, which may flow out the drain 212, exiting the container 202, and entering the sump of the water circulation system, as shown in FIG. 1. Scrubbed effluent gas 246 then exits the container 202 through the gas exit port 210 into the exhaust output channel 216. Exhaust input and output channels 214, 216 may be pipes, for instance. The exhaust input and output channels 214, 216 typically may be cylindrical, but the present invention is not limited to any particular geometry.

In both FIGS. 1 and 2, a single refrigeration device is depicted. Nonetheless, some embodiments of the present invention contemplate the incorporation of more than one refrigeration device, such that the fresh water supply, the heat exchanger, the wet scrubber container, and/or a cooling plate may have individual refrigeration devices. Alternatively, the fresh water supply may be cool or cold enough in and of itself so as to not need a separate mechanism to cool it, so the fresh water may be used as the chilled water as needed. The fresh water may be particularly cool in a facility drawing on a deep well, located in a mountainous area, or operating in a colder climate. The refrigeration device optionally may include a high differential heat exchanger to use an output of another processing system to cool the cooling system 234.

Exemplary Modified MARATHON™ System

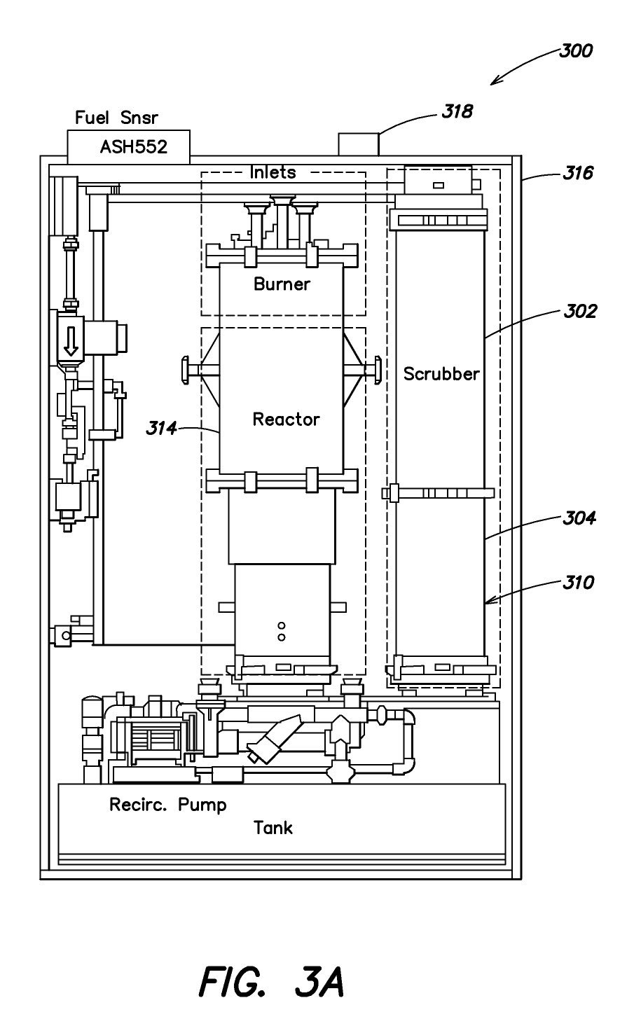

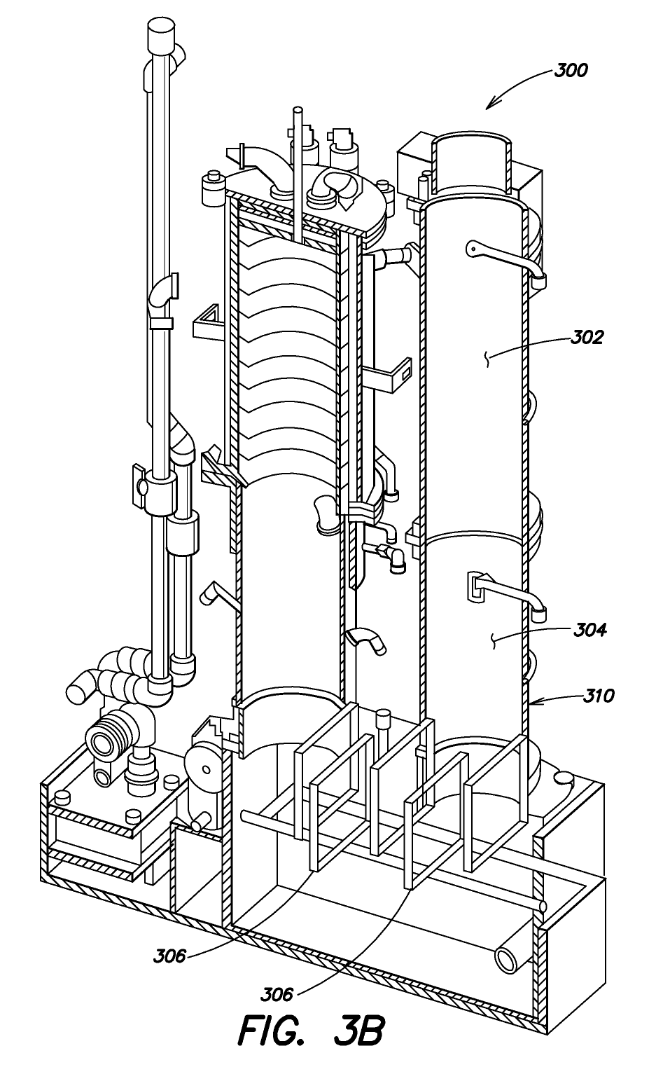

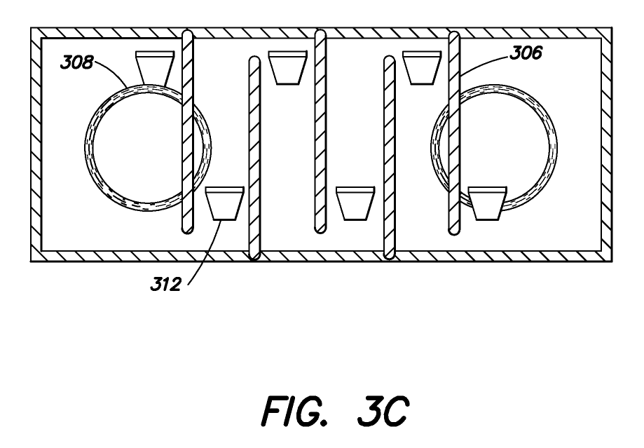

Referring to FIGS. 3A-3C, schematic drawings depict a front view, a cross-sectional perspective view, and a top sectional plan view of components of an exemplary electronic device manufacturing system 300 in accordance with an embodiment of the present invention. In accordance with various embodiments of the present invention, the electronic device manufacturing system 300 otherwise may resemble a commercially available system, such as the MARATHON™ system, shown in FIG. 3A, or CDO™ system, both from Applied Materials, Inc.

In a conventional MARATHON™ system, there are two water scrubber stages. The lower stage is fed by water drawn from the recirculation tank. This water is pumped through a heat exchanger and then through a spray jet in the lower scrubber. The upper scrubber is fed by fresh water that will likely be at ambient temperature. The temperature of the gas that enters the lower scrubber is higher than the temperature of the scrubbing liquid, so in addition to it being scrubbed of water-soluble gases, it is cooled by the lower scrubber liquid. The minimum temperature of the gas stream exiting a conventional upper scrubber is the ambient temperature of the fresh water used in the upper scrubber itself.

In a MARATHON™ system 300 modified or retrofitted to implement an embodiment of the present invention, the fresh water entering an upper scrubber 302 may be cooled below ambient temperature in accordance with aspects of the present invention, so that the particulate collection and gas scrubbing will be improved. In accordance with aspects of the present invention, the gas temperature will be sub-ambient and have a lower dew point than without the cooling. Using colder recirculation water in the lower scrubber will improve these effects.

In a modified MARATHON™ system 300, an embodiment of the present invention may use a chiller loop for the fresh water and/or lower scrubber water that may cool the water. The heat from the effluent gases could be transferred into the chilled water and removed from the scrubber water that is already being used by the modified MARATHON™ system. The work to transfer the heat could come from a vapor compression type of chiller system, or alternatively a solid state system, or any other suitable system. For the fresh water going to the upper scrubber 302, a water-chilling heat exchanger would not have to be corrosion resistant, but for the lower scrubber section 304, a water-chilling heat exchanger preferably would be corrosion resistant to handle the recirculating liquid.

In one embodiment of the present invention, reactor exhaust may be made to wind back and forth between baffles 306 under a flow of high-pressure fine water mist 308 (e.g., 10-1000 psi) before entering a scrubbing column 310. The water mist 308 may be fresh and/or chilled; there may be one or more water jet spray nozzles 312; and there may be one or more baffles 306. For example, there may be a plurality of spray jets 312 and a plurality of baffles 306, and one spray jet 312 may spray fine water mist 308 under high pressure in front of a corresponding baffle 306 in the path of the effluent gas traversing the exhaust transport system between an abatement tool 314 and the scrubber column 310.

A system such as a modified MARATHON™ system 300 may use fresh water on both the upper and lower water scrubbers to improve scrubbing and increase particulate extraction. Likewise, chilled water may be used on both the upper and lower water scrubbers 302, 304 for further improvement. Also, a cabinet exhaust may be added above the reactor exhaust to cool emissions and add 50% dew-point (DP) dry gas to suppress post abatement condensation and to improve particulate extraction and acid gas scrubbing.

Moreover, the system 300 may reside in a cabinet 316 that is ventilated by a ventilation system 318. The ventilation system 318 ventilates cabinet exhaust from within the cabinet 316. The system 300 may cross-exchange colder cabinet exhaust with hotter chemical exhaust above the system to condense saturated moisture. The cross-exchange may use enhanced surface area diffusers, such as concentric surfaces. For instance, a cross-exchange duct may have a cross-sectional geometry such as that of a star, rectangle, or other enhanced surface area shape. Such a cross-exchange of colder and hotter exhausts through enhanced surface area ducts operates to improve scrubbing of particulates and acid gas through both kinetic energy reduction and heat removal.

Additional Components of an Exemplary Electronic Device Manufacturing System

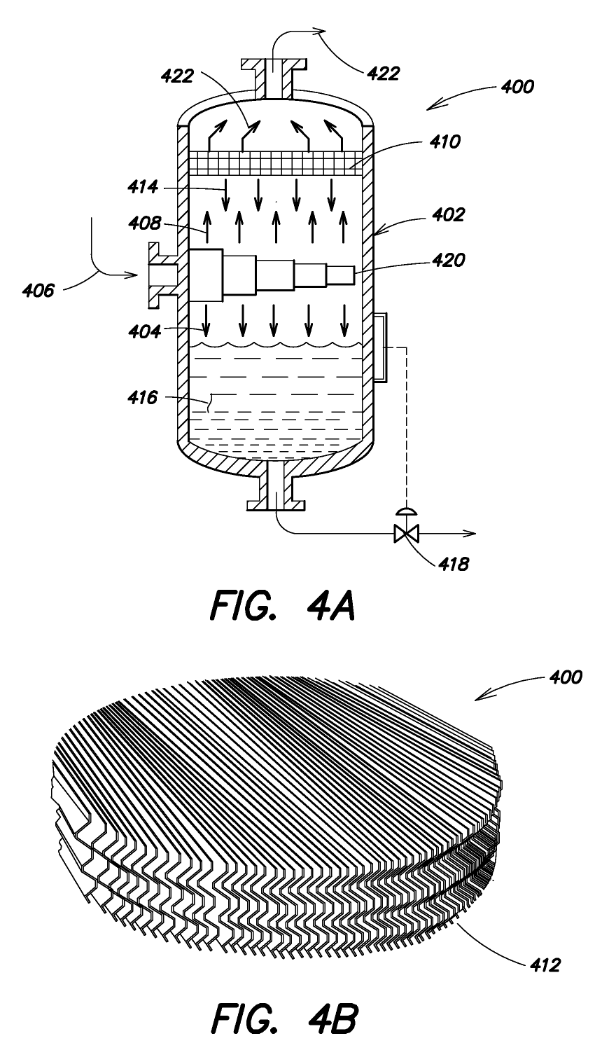

Referring to FIGS. 4A-4B, schematic drawings depict a cross-sectional front view and a perspective view of additional components 400 of another exemplary electronic device manufacturing system in accordance with another embodiment of the present invention. Some embodiments of the present invention may incorporate active or passive demisters 402, or mist eliminators 402, as shown in FIG. 4A. A demister 402 may be incorporated above a modified MARATHON™ system to aid in particulate scrubbing or moisture suppression control; e.g., water vapors 404 condense out of feed gas 406 and separate from reduced moisture gas 408. An active mist eliminator may be actively refrigerated or chilled.

A demister 402 may comprise a de-entrainment mesh pad of coarse fibers 410, or stacked Z plates 412, as shown in FIG. 4B, which may include a water wash that dumps the condensate 414 and particulates back to the abatement device sump 416 to drain 418. An optional venturi kinetic water scrubber or inlet diffuser 420 may be included as well. The water to this kinetic water scrubber could be chilled and run at high pressure and velocity. Gases 422 exiting the demister 402 will have reduced moisture content.

These demisters may comprise an additional scrubber that may be an optional, configurable module, integrated or stand-alone, added above the abatement device or integrated into the existing cabinet. For example, a modified MARATHON™ system may include a specific enhanced set of configurable and spool piece interchangeable modules that will fit above the modified MARATHON™ system to facilitate cross exchange, dry gas addition, or active/passive demisting to achieve improved scrubbing efficiency and/or improved dew point management.

In accordance with other aspects of the present invention introduced in FIGS. 1 and 2, indication information may be provided by an indication device or indication means that may be incorporated in the water circulation system, the scrubbing system, and/or the electronic device manufacturing system. The indication device or means may include automated indicated means and unautomated indication means. Similarly, the indication means may provide automated or unautomated information to an automated controller, a user, or both.

An indication device may indicate, for instance, a local temperature, pressure, or humidity. Another indication means might indicate whether there is excessive particulate accumulation or clogging in the filter, such that the flow through the system is limited unacceptably. Due to improved scrubbing of embodiments of the present invention, particulates may accumulate in the filter more quickly, requiring more frequent filter maintenance.

Automated information may include, for instance, analog or digital data provided to an automated controller and/or made perceptible by an output means, such as being converted by a gauge, displayed on a display or sounding an audible alarm. Unautomated information may include, for instance, visual information, such as a view of a duct, or a view of a filter. Unautomated information also may include audio information, such as a sound from a pressure whistle, but might also include noise of a rattle or other sound-making device, such as when a temperature rises to or above a threshold level.

Similarly, automated indication means may include, for example, one or more sensors, measurement devices, or computing devices. Exemplary sensors may include temperature or pressure sensors that monitor the temperature or pressure of water flowing through the scrubbing system or water circulation system. Similarly, a temperature sensor may monitor a temperature of a process system component, such as a heat exchanger, where an increased temperature may indicate a problem. Other measurement devices may include a flow meter before and after the chilled water source.

Likewise, a time measurement device may measure a usage duration of system usage, or an event duration between PM events, whereupon attainment of a threshold duration may prompt performance of a PM event to clean the ductwork or dispose of the recirculated water. Similarly, a computing device may perform various calculations from data collected from existing system data inputs, where certain calculated values are correlated with system usage, a PM event or a direct need to perform maintenance or repairs. For instance, due to increased particulate extraction from the reduced temperature scrubbing system, particulates may accumulate in the filter more quickly, so data may indicate that the filter is clogging and implicating the direct need to unclog the filter.

Even though the amount of particulates produced by the system may not change, the length of time until the ductwork needs to be cleaned and/or repaired may be extended by aspects of the present invention. Likewise, aspects of the present invention may remove ductwork clogging as a limiting factor for mean time between service (MTBS). Furthermore, with the possibility to automate the temperature adjustment process, operator involvement may be reduced and possible operator-involvement-based inefficiencies may be reduced. For instance, the system could be set up so that the system automatically optimizes the chilled water temperature and mixing ratios according to the types of contaminants to be extracted and the process being used to create them.

Various Method Embodiments

In a method embodiment of the present invention, a method of making a reduced-temperature wet scrubbing system is provided. In this embodiment, the method may include providing a wet scrubber as described herein. The method also may include providing a cooling system, an abatement tool or both. The method further may include connecting the cooling system and/or abatement tool to the reduced-temperature wet scrubbing system. In addition, the method may include providing a microelectronic structure and electronic device manufacturing system, and connecting the electronic device manufacturing system to the reduced-temperature wet scrubbing system. Furthermore, the method may include providing a demister and connecting the demister to the abatement tool. The method also may include providing baffles, spray jets, or both along a path between an abatement tool and a scrubbing column.

In another embodiment, a method of operating a microelectronic structure and electronic device manufacturing system is provided. In this embodiment, the method may include providing an electronic device manufacturing system that includes an abatement system having a cooling system as described herein; operating the abatement system; and using the cooling system to operate a wet scrubber at a cold temperature. The method also may include generating particulates during operation of the abatement system; extracting the particulates using a reduced temperature wet scrubber; and flushing the particulates with water into a water circulation system. The method may further comprise filtering the particulates from the water circulating through the water circulation system. In addition, the method may include channeling effluent gas along a path between an abatement tool and a scrubbing column, wherein the path include baffles, spray jets, or both. Moreover, the method may include spraying high-pressure fine water mist through the spray jets as the effluent gas traverses the path around the baffles.

In another embodiment, a method of scrubbing effluent gases is provided. In this embodiment, the method may include providing a reduced-temperature wet scrubbing system as described herein and operating the wet scrubbing system at a reduced temperature. The method further may comprise providing chilled water to a scrubbing container, spraying chilled water on effluent gas and a packed bed in the scrubbing container. Likewise, the method may include adjusting the temperature of the chilled water sprayed on the effluent gas and packed bed. The method also may include providing indication information indicating when the temperature and flow of coolant, e.g., water, are outside of selected operating ranges, and adjusting the temperature and flow of coolant based on the indication information. The step of adjusting the temperature and flow of coolant may include automatically adjusting the cooling system.

In another embodiment, a method of operating a wet scrubbing system is provided. In this embodiment, the method may include providing a wet scrubbing system as described herein, and adjusting the temperature of the scrubbing system to be within a range of reduced temperatures. The step of adjusting the temperature may include adjusting a mixture of fresh water, recirculated water and chilled water to achieve a reduced temperature within the range.

Aspects of the present invention may include performing one or more actions of method embodiments by using computer software executed on computer hardware. Parameters and logic corresponding to these actions may be embodied in computer programming code for compilation and execution by computer processors. The computer processors executing the code may adjust the performance of the actions based in part, for instance, on system data, process feedback, or user input, as is customary with the automation of manufacturing processes and/or equipment. For example, temperature sensors may provide temperature data which may trigger computer instructions to adjust coolant flow rates. In conjunction with the automation of one or more aspects of a system in accordance with an embodiment of the present invention, computer software for process and/or equipment automation may be embodied in computer readable media or in inter-computer communication, either in compiled or uncompiled formats. Inter-computer communication may include, for instance, remote access and/or control of on-site equipment by off-site software or hardware under third-party control.

Possible Advantages

Embodiments of the present invention may experience one or more of several advantages. As discussed, colder fresh and recirculating water spray may improve the trapping efficiency of particulates from the tool exhaust and particulates generated by the oxidation furnace in the abatement device. Using colder recirculating and fresh water to create colder effluent gases may reduce deposit of particulates in the house exhaust ductwork by (a) more efficiently scrubbing the smaller particulates in the scrubbing system and (b) decreasing the amount of fine water droplets in the house exhaust ductwork that can trap fine particulates and cause them to settle. Many of these fine particulates would be so fine that they otherwise would not condense in the house exhaust if it were not for the presence of water droplets that make them large and massive enough such that gravity becomes significant and they settle in the house duct work.

Inasmuch as a wet scrubber using colder fresh water and recirculating water may decrease the amount of water vapor in each liter of exhaust flow, the chances of exhaust line water formation through cooling of 100% saturated or super saturated scrubbed exhaust are decreased. This may reduce cost of operation (CoO) by reducing the amount of compressed dry air (CDA), or other diminished dew point gas, addition required to assure no down stream water condensation in the house exhaust, whereby a mixture of effluent gas would be formed that is not saturated or super saturated at the temperature and pressure of the house exhaust.

In addition to improved scrubbing of the effluent gases, embodiments of the present invention using colder fresh water and lower-temperature recirculating water may encounter decreased corrosion, insofar as corrosion mechanisms of acids on metal alloys are almost always temperature dependant. For instance, the corrosion rate in mils per year can increase 100% for each 10° centigrade increase in operating temperature. Thus, by decreasing the operating temperature, aspects of the present invention may reduce the corrosive impacts on any metal components including valves, tubing, seals, and the heat exchanger.

Colder fresh water addition to the exhaust, on top of or after the water scrubbing packed column or water inductor, may also improve acid gas scrubbing efficiency due to the lowering of the fugacity, also known as Henry's law partition coefficient. This may result in improved acid gas scrubbing as a consequence of the reduction of the vapor pressure of acid gas over the colder water, a phenomenon very similar to thermophoresis with particulates. Fugacity and Henry's law describe the gas interaction with the liquid phase. An ideal gas has a fugacity of one, whereas a non-ideal gas will have a fugacity of less than one. For ideal gases, Henry's law describes the distribution of gases in gas phase when a gas dissolves in a liquid phase, over any liquid into which the gas can dissolve. For non-ideal gases, fugacity describes how the gas behaves with bulk liquid, e.g., hydrogen bonding may cause a gas to behave non-ideally. Nonetheless, in most cases, gas is more soluble in cold water than it is in hot water, irrespective of its fugacity.

Thus, colder exhaust may reduce dew point saturation and corrosion in the house exhaust. Colder unsaturated exhaust may reduce or minimize the formation of acid gas condensation in locations where some water in the house exhaust inevitably may collect. A pool of such water may scrub some of the acid gases. However, such water also may evaporate periodically, as ambient conditions vary, and once these water droplets containing acid gases evaporate, a residue of concentrated acid may be left behind and cause pitting corrosion.

The foregoing description discloses only exemplary embodiments of the invention. Modifications of the above disclosed systems, apparatus and methods which fall within the scope of the invention will be readily apparent to those of ordinary skill in the art.

For instance, this process may be used in other applications that also suffer from the problems typical of effluent gases exiting conventional wet scrubbers, where the effluent gases are high in particulates, the effluent gases have a high dew point, or an exhaust scrubber could use improved efficiency.

Accordingly, while the present invention has been disclosed in connection with exemplary embodiments thereof, it should be understood that other embodiments may fall within the spirit and scope of the invention, as defined by the claims of the patent issued to the present invention.

The invention claimed is:

1. A reduced-temperature wet scrubbing system comprising:
a wet scrubber adapted to be operated at an operating temperature within a range of reduced temperatures; and
a cooling system adapted to maintain the wet scrubber within the range of reduced temperatures;
wherein the range of reduced temperatures is below 23° C.

2. The system of claim 1, wherein the cooling system comprises:
a coolant adapted to flow from the cooling system to the wet scrubber;
wherein the coolant is further adapted to cool the wet scrubber to within the range of reduced temperatures.

3. The system of claim 2, wherein the coolant comprises chilled water having a coolant temperature of between 0° C. and 15° C.

4. The system of claim 1, wherein the range of reduced temperatures is from 2° C. to 20° C.

5. The system of claim 1, further comprising:
a demister;
wherein the wet scrubbing system is adapted to be connected to an abatement tool and is further adapted to be connected to a water circulation system; and
wherein the demister is adapted to be connected to the abatement tool, the water circulation system, or both.

6. The system of claim 5, further comprising:
an indication device;
wherein the indication device is adapted to provide indication information indicating whether the wet scrubber is being operated within the range of reduced temperatures.

7. The system of claim 6, further comprising:
a controller in communication with the indication device;
wherein the controller is adapted to control the cooling system to maintain the wet scrubber within the range of reduced temperatures.

8. The system of claim 1, wherein the cooling system comprises:
a refrigeration device;
wherein the refrigeration device is adapted to cool the wet scrubber to within the range of reduced temperatures.

9. The system of claim 1, wherein the cooling system comprises:
a source of chilled water; and
a water input channel adapted to connect the source of chilled water to the wet scrubber;
wherein the wet scrubber includes nozzles adapted to spray the chilled water within the wet scrubber to cool the wet scrubber to the operating temperature within the range of reduced temperatures.

10. The system of claim 9, further comprising:
at least one baffle; and
at least one spray jet connected to the source of chilled water;
wherein the at least one baffle and the at least one spray jet are disposed along a path taken by effluent gas to enter the wet scrubber, and
wherein the at least one spray jet is adapted to spray the chilled water at effluent gas traversing the path around the at least one baffle.

11. A method of scrubbing effluent gas, the method comprising:
providing a reduced-temperature wet scrubbing system; and
operating the reduced-temperature wet scrubbing system at an operating temperature within a range of reduced temperatures;
wherein the reduced-temperature wet scrubbing system comprises:
a wet scrubber adapted to be operated at the operating temperature within the range of reduced temperatures; and
a cooling system adapted to maintain the wet scrubber within the range of reduced temperatures;
wherein the range of reduced temperatures is below 23° C.

12. The method of claim 11, further comprising:
causing a coolant to flow from the cooling system to the wet scrubber;
wherein the coolant is further adapted to cool the wet scrubber to within the range of reduced temperatures.

13. The method of claim 12, wherein the coolant comprises chilled water having a coolant temperature of between 0° C. and 15° C.

14. The method of claim 11, wherein the range of reduced temperatures is from 2° C. to 20° C.

15. The method of claim 11, further comprising:
providing indication information indicating whether the wet scrubber is operating at the operating temperature within the range of reduced temperatures.

16. The method of claim 15, further comprising:
adjusting the cooling system based on the indication information.

17. The method of claim 16, wherein adjusting the cooling system comprises automatically adjusting the cooling system.

18. The method of claim 11, further comprising:
providing a processing system comprising an abatement system including the reduced-temperature wet scrubbing system;
operating the abatement system;
generating the effluent gas while operating the abatement system; and
scrubbing contaminant by-products from the effluent gas with chilled water.

19. A method of making a reduced-temperature wet scrubbing system, the method comprising:
providing a wet scrubber adapted to be operated at an operating temperature within a range of reduced temperatures; and
providing a cooling system adapted to maintain the wet scrubber within the range of reduced temperatures;
wherein the range of reduced temperatures is below 23° C.

20. The method of claim 19, further comprising:
connecting the cooling system to the wet scrubber;
wherein providing the cooling system comprises providing a source of cooled liquid, the cooled liquid adapted to flow from the cooling system to the wet scrubber; and
wherein the cooled liquid is further adapted to cool the wet scrubber to within the range of reduced temperatures.

21. A method of making a microelectronic structure processing system, the method comprising:
providing a reduced-temperature wet scrubbing system, the reduced-temperature wet scrubbing system comprising:
a wet scrubber adapted to be operated at an operating temperature within a range of reduced temperatures; and
a cooling system adapted to maintain the wet scrubber within the range of reduced temperatures;
wherein the range of reduced temperatures is below 23° C.

22. The method of claim 21, further comprising:
providing an abatement tool;
connecting the abatement tool to the reduced-temperature wet scrubbing system;
providing a demister; and
connecting the demister to the abatement tool or the reduced-temperature wet scrubbing system.

23. The method of claim 21, further comprising:
providing at least one baffle and at least one spray jet along a path between the abatement tool and a scrubbing column of the wet scrubber.

24. The method of claim 21, wherein providing the reduced-temperature wet scrubbing system comprises:
providing a source of cooled liquid, the cooled liquid adapted to flow from the cooling system to the wet scrubber;
wherein the cooled liquid is further adapted to cool the wet scrubber to within the range of reduced temperatures.

25. A microelectronic structure processing system comprising:
a reduced-temperature wet scrubbing system comprising:
a wet scrubber adapted to be operated at an operating temperature within a range of reduced temperatures; and
a cooling system adapted to maintain the wet scrubber within the range of reduced temperatures;
an abatement tool connected to the reduced-temperature wet scrubbing system; and
a water circulation system connected to the abatement tool and the reduced-temperature wet scrubbing system;
wherein the range of reduced temperatures is below 23° C.
